(19) United States
(12) Patent Application Publication
(10) Pub. No.: US 2008/0069705 A1
(43) Pub. Date: Mar. 20, 2008

(54) HEAT EXCHANGE DEVICE AND FUEL SUPPLY DEVICE

(75) Inventor: Hiroyuki Fujimoto, Obu-shi (JP)

Correspondence Address: DENNISON, SCHULTZ & MACDONALD, 1727 KING STREET, SUITE 105, ALEXANDRIA, VA, 22314, US

(73) Assignee: AISAN KOGYO KABUSHIKI KAISHA, Obu-shi (JP)

(21) Appl. No.: 11/854,026

(22) Filed: Sep. 12, 2007

(30) Foreign Application Priority Data
Sep. 15, 2006 (JP) 2006-251355

(51) Int. Cl. F02M 37/14; F04B 23/00

(52) U.S. Cl. 417/313; 123/557

(57) ABSTRACT

A heat exchange device is provided with a partition wall and a heat radiation member. The partition wall separates a first space from a second space. The partition wall is made from a resin. The partition wall includes a through hole extending from the first space to the second space. The heat radiation member is fixed to the through hole. The heat radiation member is made from a metal. One end of the heat radiation member is disposed within the first space and the other end of the heat radiation member is disposed within the second space. An outer surface of the heat radiation member and an inner surface of the through hole are chemically bonded, whereby a gap between the heat radiation member and the through hole is sealed.

### CROSS-REFERENCE TO RELATED APPLICATION

This application claims priority to Japanese Patent Application No. 2006-251335, filed on Sep. 15, 2006, the contents of which are hereby incorporated by reference into the present application.

### BACKGROUND OF THE INVENTION

1. Field of the Invention

The present invention relates to a heat exchange device and a fuel supply device comprising the heat exchange device.

2. Description of the Related Art

A heat exchange device that serves to radiate heat of a beat generating member to a fluid (e.g., gas or liquid) via a heat radiation member is known. Such a heat exchange device is used, for example, in a fuel supply device that supplies fuel to an automobile engine.

A fuel supply device is disclosed in Japanese Laid-open Patent Application Publication No. 2001-99029. This fuel supply device comprises an attachment member, a fuel pump and a control circuit. The attachment member is attached to a mounting opening of a fuel tank. The fuel pump is fixed to the attachment member. The fuel pump is disposed inside the fuel tank when the attachment member is attached to the mounting opening. The control circuit controls the fuel pump. The attachment member is made from a resin material and comprises a fuel pipe extending from the inside of the fuel tank to the outside of the fuel tank exterior. The fuel pump discharges the fuel inside the fuel tank to the outside of the fuel tank via a fuel pipe. The control circuit drives the fuel pump by using electric power supplied from an external power source. The control circuit includes heat generating circuit components. The attachment member has an inner space within which the control circuit is disposed. The control circuit is disposed on the heat radiation plate embedded in the attachment member. The fuel pipe passes through the heat radiation plate. In such a fuel supply device, when the fuel pump is driven, the fuel inside the fuel tank is discharged to the outside of the fuel tank via the fuel pipe. The heat generated by the control circuit is radiated via the heat radiation plate to the fuel flowing inside the fuel pipe. As a result, the control circuit is prevented from being heated to a high temperature.

### BRIEF SUMMARY OF THE INVENTION

With the technology described in the aforementioned document, the fuel pipe is provided to pass through the heat radiation plate (i.e., heat radiation member), whereby the heat of the control circuit is radiated to the fuel flowing inside the fuel pipe. However, the contact surface area of the heat radiation member and the fuel pipe is small. Further, the heat radiation member radiates heat only to the fuel flowing inside the fuel pipe. As a result, the heat of the control circuit cannot be sufficiently radiated.

In order to resolve this problem, a structure can be considered in which one end of the heat radiation member is immersed directly into the liquid (i.e., fuel inside the fuel tank). In such structure, a through hole is formed in a partition wall that partitions the inside of a fuel tank (i.e., outside of the attachment member) and the inside of the attachment member (i.e., inner space where a control circuit is accommodated). A heat radiation member is fixed in this through hole. One end of the heat radiation member is disposed inside the attachment member, and the other end is immersed into the fuel inside the fuel tank. As a result, the heat of the control circuit is radiated via the heat radiation member to the entire fuel located inside the fuel tank.

When the above-described structure is employed, a through hole is formed in the partition wall that partitions the inside of the fuel tank (i.e., liquid space) and the inside of the attachment member (i.e., gas space where the control circuit is accommodated). As a result, this structure needs to be equipped with both a method of fixing the heat radiation member to the through hole and a method of sealing between the beat radiation member and the through hole. Sealing between the heat radiation member and the through hole can be performed with an O-ring. However, with such a configuration, another structure is necessary for fixing the heat radiation member to the through hole. Thus, the structure becomes complex and the cost thereof increases. On the other hand, where a structure is used in which the heat radiation member is fixed to the through hole with an adhesive, the space between the two can be sealed with the adhesive that fixes the heat radiation member to the through hole. However, because the adhesive is degraded under the effect of heat of the heat radiation member or liquid, the seal can become defective.

It is an object of the present teachings to provide a technology that makes it possible to perform fixing of the heat radiation member to the through hole and sealing of the gap between the heat radiation member and the through hole in an easy manner and to seal the gap between the heat radiation member and the through hole with good stability.

In one aspect of the present teachings, a heat exchange device is provided with a partition wall and a heat radiation member. The partition wall separates a first space from a second space. The partition wall is made from a resin. The partition wall includes a through hole extending from the first space to the second space. The heat radiation member is fixed to the through hole. The heat radiation member is made from a metal. One end of the heat radiation member is disposed within the first space and the other end of the heat radiation member is disposed within the second space. A bonding layer (e.g., polymer layer) is chemically bonded to both of an outer surface of the beat radiation member and an inner surface of the through hole. The bonding layer seals a gap between the heat radiation member and the through hole.

In such a heat exchange device the bonding layer is chemically bonded to both of the partition member made from a resin and the heat radiation member made from a metal. As a result, degradation caused by beat or liquid can hardly occur in the joint portion of the partition member and the heat radiation member. Therefore, the gap between the through hole and the heat radiation member can be sealed with good stability. Furthermore, because the gap between the two is sealed by the bonding layer that fixes the heat radiation member to the through hole, fixing and sealing of the partition member and heat radiation member can be performed with a simple structure.

Other objects, features and advantages of the present teachings will be readily understood after reading the following detailed description together with the accompanying drawings and claims. The additional features and aspects disclosed herein may be utilized singularly or, in combination with the above-described aspect and features.

### BRIEF DESCRIPTION OF THE DRAWINGS

FIG. 1 is a front view of the fuel supply device of a representative embodiment of the preset teachings.

FIG. 2 is a side view of the fuel supply device of the representative embodiment.

FIG. 3 is a cross-section view along the III-III line in FIG. 2.

FIG. 4 is atop view of the heat exchange device.

FIG. 5 is a side view of the heat exchange device.

FIG. 6 is a vertical sectional view of the heat exchange device.

FIG. 7 is a vertical sectional view of another embodiment of the heat exchange device.

FIG. 8 is a schematic vertical sectional view of another representative embodiment of the heat exchange device.

FIG. 9 is a schematic vertical sectional view of another representative embodiment of the heat exchange device.

FIG. 10 is a schematic perspective sectional view of another representative embodiment of the heat exchange device.

FIG. 11 is a schematic vertical sectional view of another representative embodiment of the heat exchange device.

### DETAILED DESCRIPTION OF THE INVENTION

Main features of the technology described in the embodiments are listed below

(Feature 1) A triazinethiol derivative is coated on the surface of a heat radiation member by using an electrochemical surface treatment method.

(Feature 2) The heat radiation member coated with a triazinethiol derivative is disposed in a mold, a resin is injected into the mold, and a partition member is molded.

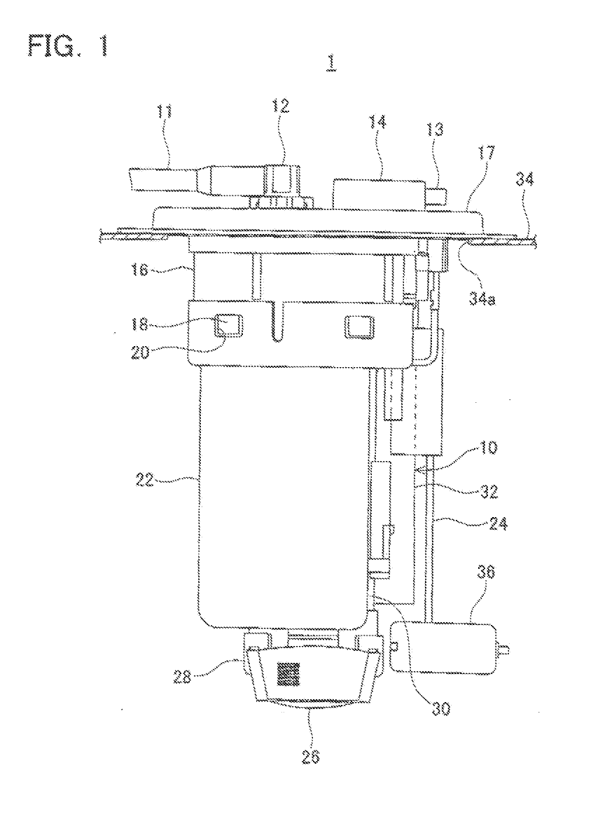

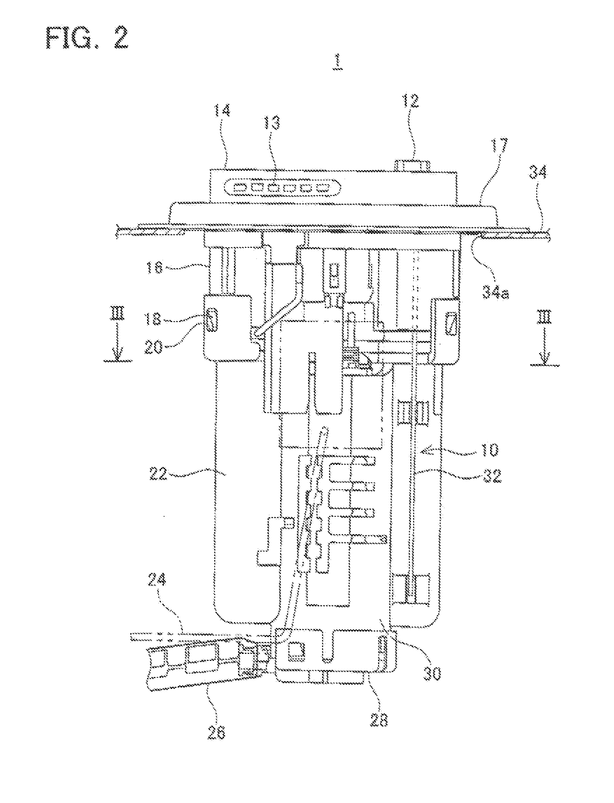

A fuel supply device 1 according to a representative embodiment of the present teachings will be explained using the appended drawings. As shown in FIGS. 1-3, the fuel supply device 1 comprises a heat exchange device 10 and a fuel pump 31.

The heat exchange device 10 has a set plate 17 made from an electrically insulating resin material. The set plate 17 is attached to a mounting opening 34a formed in the upper surface of a fuel tank 34. An accommodation portion 14 and a discharge pipe attachment portion 12 are formed on the upper surface (i.e., surface on the outer side of the fuel tank 34) of the set plate 17. Where the set plate 17 is attached to the mounting opening 34a, the mounting opening 34a is closed by the set plate 17. As a result, the fuel located inside the fuel tank 34 is prevented from flowing to the outside of the fuel tank 34. In other words, the set plate 17 serves as a partition member that partitions the accommodation portion 14 formed at the upper surface of the set plate 17 and the interior of the fuel tank 34 arranged on the lower surface side of the set plate 17.

The accommodation portion 14 accommodates inside thereof a control module A connector 13 is molded in the accommodation portion 14 integrally therewith. The control module is connected to the connector 13. A power source such as a battery (not shown) is connected to a terminal of the connector 13. A discharge pipe 11 is attached to the discharge pipe attachment portion 12. An injector (not shown) is connected to other end of the discharge pipe 11. The fuel discharged from the fuel supply device 1 to the discharge pipe 11 is supplied to an engine (not shown) via the injector.

A bracket portion 16 and a heat radiation plate 32 extend from the lower surface (i.e., surface on the inner side of the fuel tank 34) of the set plate 17 toward the inside of the fuel tank 34. The bracket portion 16 is molded integrally with the set plate 17. An attachment piece 18 is formed at the lower end of the bracket portion 16. The attachment piece 18 engages with an engagement opening 20 of a filter case 22. By engaging the attachment piece 18 with the engagement opening 20, the filter case 22 is joined to the set plate 17. A fuel pump case 30 is joined to the filter case 22.

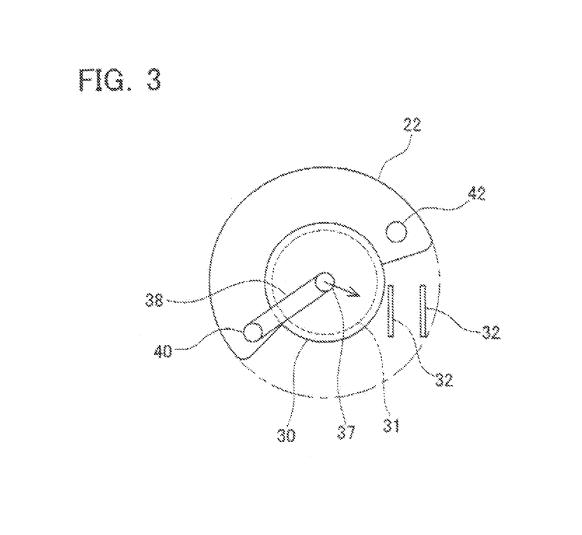

The fuel pump 31 is disposed within the fuel pump case 30. A suction filter 26 is attached by an attachment piece 28 to a fuel intake port (not shown) at the lower end of the fuel pump 31. The suction filter 26 removes comparatively large foreign matter from the fuel sucked into the fuel pump 31. As shown in FIG. 3, one end of a connection pipe 38 is attached via a pressure regulator 37 to a fuel discharge port at the upper end of the fuel pump 31. The pressure regulator 37 has a function of adjusting the pressure of fuel discharged from the fuel pump 31 and returning the excess portion of the fuel discharged from the fuel pump 31 into the fuel tank 34. The control module within the accommodation portion 14 is connected via a lead wire to an electric motor of the fuel pump 31.

As shown in FIG. 3, the filter case 22 has a circular arc shape, when viewed from the side of the set plate 17. A fuel pump case 30 is arranged inside the filter case 22. A fuel filter (not shown) is accommodated inside the filter case 22. The fuel filter removes fine foreign matter from the fuel discharged from the fuel pump 31. A fuel inflow port 40 and a fuel discharge port 42 are formed in the upper surface of the filter case 22. The fuel inflow port 40 is connected to the fuel discharge port of the fuel pump via the connection pipe 38. The fuel discharge port 42 is connected to the discharge pipe attachment portion 12 of the set plate 17 by a pipe (not shown).

The heat radiation plate 32 that hangs down from the lower surface of the set plate 17 is formed from a metal material having a high thermal conductivity (e.g., aluminum, copper). The lower end of the heat radiation plate 32 extends close to the lower end of the fuel supply device (that is, close to the lower end of the fuel tank 34). Therefore, the lower end of the heat radiation plate 32 is immersed into the fuel inside the fuel tank 34. The upper end of the heat radiation plate 32 passes through a through hole 17a formed in the set plate 17 and is positioned at the upper surface of the set plate 17. As described below, the control module comes into contact with the upper end of the heat radiation plate 32.

As shown in FIG. 3, the fuel supply device 1 comprises two heat radiation plates 32, 32. The heat radiation plates 32, 32 are disposed on the outer periphery of the fuel pump case 30 in a portion where the filter case 22 is not disposed. More specifically, the heat radiation plates 32, 32 are disposed on the outer periphery of the fuel pump case 30 in the ejection direction (shown by an arrow in the figure) of the fuel returned from the pressure regulator 37 into the fuel tank 34. As a result, where the fuel pump 31 is driven and excess fuel is returned from the pressure regulator 37 into the fuel tank 34, this fuel is ejected (spurt) in the direction of heat radiation plates 32, 32 and comes into contact with the heat radiation plates 32, 32.

Furthermore, the heat radiation plates 32, 32 are disposed inside a circle (a circle shown by a dot-dash line in the figure) having the center of the fuel supply device as a center and having a radius equal to a distance from the center to the outer periphery of the filter case 22 (i.e., the fuel filter) in a plane perpendicular to the axial line of the fuel supply device 1 (i.e., in a plane parallel to the set plate 17). As a result, the fuel supply device 1 is prevented from being increased in size by the heat radiation plates 32, 32, and the fuel supply device 1 can be made more compact. The fuel supply device 1 also has a fluid level meter. As shown in FIG. 1, the fluid level meter has a float 36, an arm 24, and a sensor unit (not shown). The fluid level meter may have a conventional structure and the explanation thereof is herein omitted.

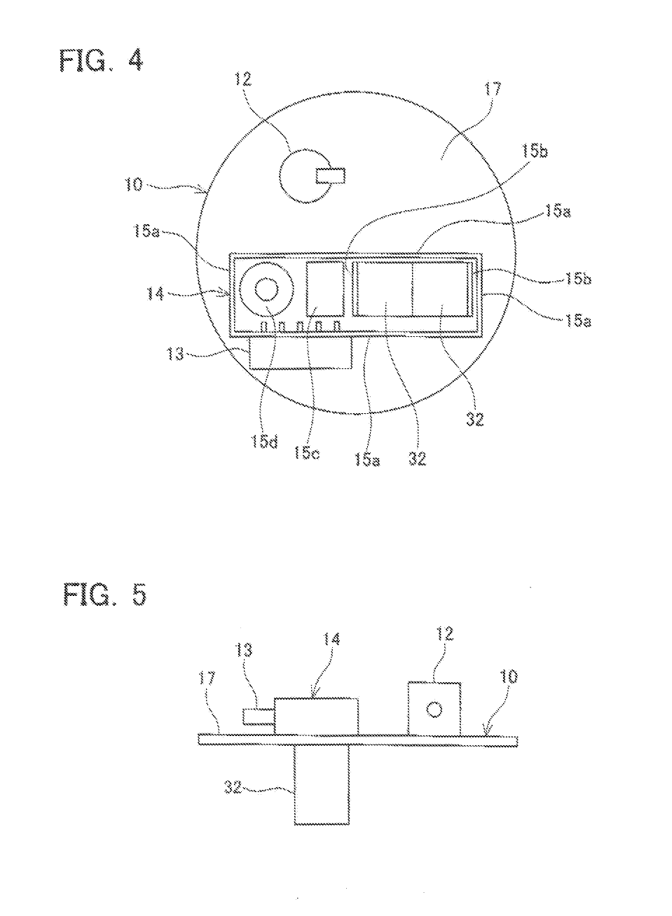

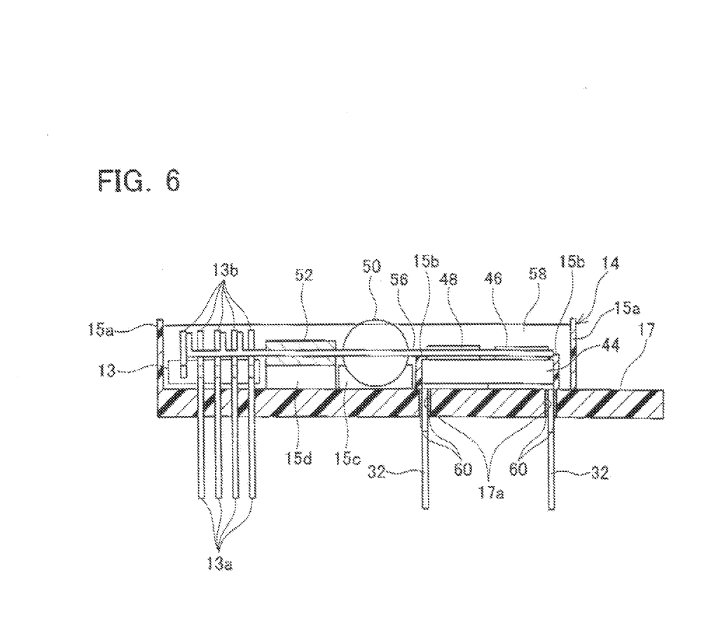

The accommodation portion 14 and the control module mounted inside the accommodation portion 14 will be described below. As shown in FIGS. 4 and 5, the accommodation portion 14 is formed to have a rectangular parallelepiped shape by four wall portions 15a provided vertically on the upper surface of the set plate 17. The connector 13 is molded integrally with one of the four wall portions 15a. The upper surface of the accommodation portion 14 is open. The upper end portions of the two heat radiation plates 32, 32 are disposed inside the accommodation portion 14. Thus, the heat radiation plates 32, 32 pass through the set plate 17. The upper ends of the heat radiation plates 32, 32 are positioned above the set plate 17, and the lower ends of the heat radiation plates 32, 32 are positioned below the set plate 17 (inside the fuel tank 34). As described below, the heat radiation plate 32 and the through hole 17a of the set plate 17 are joined together by chemical bonding, and a bonding layer 60 (see FIG. 6) is formed between the heat radiation plate 32 and the set plate 17.

The upper end portions of the heat radiation plates 32, 32 are bent toward the other heat radiation plate, respectively. One surface (i.e., lower surface) of the upper end portion of the heat radiation plate 32 abuts against the upper surface of the set plate 17. In a bent state of the heat radiation plates 32, 32, the upper end edges of the heat radiation plates 32, 32 are brought close to each other to obtain a substantially gapless state. Holding pieces 15b, 15b are formed in the vicinity of the bent portions of the heat radiation plates 32, 32. The holding pieces 15b, 15b hold a heat sink 44. A capacitor holding portion 15c and a coil holding portion 15d are formed on the side of one holding piece 15b.

As shown in FIG. 6, a control module is mounted on the above-described accommodation portion 14. The control module is composed of the heat sink 44, electronic elements 46, 48 fixed on the heat sink 44, a capacitor 50, a choke coil 52, and a bus bar 56. The heat sink 44 is formed from a metal material having a high thermal conductivity (e.g., aluminum, copper). The bottom surface of the heat sink 44 abuts against the heat radiation plates 32, 32. The heat sink 44 is held on the heat radiation plates 32, 32 by the holding pieces 15b, 15b.

The electronic elements 46, 48 include diodes and power transistors (e.g., MOS transistors). The electronic elements 46, 48 constitute a pump drive circuit. The pump drive circuit converts a direct current supplied from an external power source into a pump drive power source and supplies it to the fuel pump.

The capacitor 50 is fixed to the capacitor holding portion 15c, and the choke coil 52 is fixed to the coil holding portion 15d. The capacitor 50 and choke coil 52 reduce electric noise generated by the electronic elements 46, 48. The bus bar 56 connects the above-described elements (electronic elements 46, 48, capacitor 50, and choke coil 52). One end of the bus bar 56 is connected to a terminal 13b of the connector 13. A lead wire 13a is connected to the terminal 13b. The other end of the lead wire 13a is connected to the fuel pump 31 and the like. The space between the accommodation portion 14 and the control module is filled with a potting material 58. The potting material 58 prevents moisture or dust from penetrating into the control module.

One example of a procedure of forming a bonding layer 60 that is chemically bonded to both of the set plate 17 and the heat radiation plates 32, 32 will be explained below. First, a triazinethiol derivative is coated on the surface of the metallic heat radiation plate 32. By this surface treatment, the triazinethiol derivative layer is chemically bonded to the heat radiation plate 32. An electrochemical surface treatment method such as a cyclic method) a constant current method, or a constant potential method may be used to cover the triazinethiol derivative on the heat radiation plate 32. When the triazinethiol derivative is coated, the heat radiation plate 32 may be used as an anode, and platinum may be used as a cathode. In addition to platinum, any material that does not react with an electrolytic solution and does not have a very low electric conductivity, for example, titanium and carbon can be used for the cathode. An aqueous solution or a triazinethiol derivative or an organic solvent is used for the electrolytic solution Any substance that dissolves in the solvent and has electric conductivity and stability may be used as solute, examples thereof including NaOH and Na₂CO₃. Methods for forming a triazinethiol derivative are fully disclosed in Japanese Laid-open Patent Application Publications No. 2-298284 and No. 2001-1445 and detailed explanation thereof is herein omitted The heat radiation plate 32 coated with the triazinethiol derivative is disposed inside a mold, and the set plate 17 is then insert molded by injecting a resin into the mold. In this process, the triazinethiol derivative layer coated on the heat radiation plate 32 is chemically bonded to the set plate 17 by the heat and pressure of the resin injected into the mold. As a result, the bonding layer 60 that chemically bonds the heat radiation plate 32 and set plate 17 is formed.

In the above-described embodiment, the set plate 17 is molded after the heat radiation plate 32 is bent, but the heat radiation plate 32 may be bent after the heat radiation plate 32 and set plate 17 have been integrally molded. When such a method is employed, the set plate 17 can be molded in a state in which the upper end and lower end of the heat radiation plate 32 are held. Therefore, the heat radiation plate 32 can be prevented from tumbling under the effect of resin pressure during molding. Further, the bent heat radiation plate 32 rises above the upper surface of the set plate 17 due to springback. As a result, where the heat sink 44 is disposed on the heat radiation plate 32, a force biasing the heat sink 44 upward is applied from the heat radiation plate 32 to the heat sink 44. Therefore, the heat sink 44 is strongly held by the holding piece 15b. Where the set plate 17 is molded, components (44, 46, 48, 50, 52, 56) constituting the control model, are mounted on the set plate 17.

The operation of the fuel supply device 1 will be described below. When a control signal designating the drive of the fuel pump is inputted to the control module, the electronic elements 46, 48 of the control module are actuated (i.e., the switching element of the power transistor is switched on). As a result, the direct current power supplied from an external power source is converted into a drive voltage and outputted to the fuel pump 31, whereby the electric motor of the fuel pump 31 start rotating.

When the electric motor of the fuel pump rotates, the fuel inside the fuel tank 34 is sucked into the fuel pump 31 via the suction filter 26. A pressure of the fuel sucked into the fuel pump 31 rises, and the pressurized fuel is discharged from the fuel discharge port of the fuel pump 31. The fuel discharged from the fuel pump 31 flows into the filter case 22 via the connection pipe 38, while the fuel pressure is adjusted by the pressure regulator 37. The fuel that has flown into the filter case 22 is filtered of comparatively small foreign matter with the fuel filter accommodated inside the filter case 22 and discharged from the fuel discharge port 42. The fuel discharged from the fuel discharge port 42 flows inside the discharge pipe 11 attached to the discharge pipe attachment portion 12 of the set plate 17 and is supplied to the engine.

When the electronic elements 46, 48 of the control module are actuated, the electronic elements 46, 48 generate heat. Heat generated by the electronic elements 46, 48 is transmitted to the upper end portion of the heat radiation plate 32 via the heat sink 44. The lower end of the heat radiation plate 32 passes through the set plate 17 and protrudes into the fuel tank 34. This lower end extends to the vicinity of the lower end of the fuel supply device 1. Therefore, the lower end of the heat radiation plate 32 is immersed into the fuel stored in the fuel tank 34. The heat transmitted to the heat radiation plate 32 is released to the fuel inside the fuel tank 34. As a result, the electronic elements 46, 48 are cooled.

Further, the excess portion of the fuel discharged from the fuel pump 31 is returned from the pressure regulator 37 into the fuel tank 34. The fuel returned from the pressure regulator 37 to the fuel tank 34 is ejected toward the heat radiation plate 32. Therefore, even when the amount of fuel inside the fuel tank 34 is small, the fuel returned by the pressure regulator 37 is sprayed and brought into contact with the heat radiation plate 32, thereby cooling the heat radiation plate 32. Therefore, the heat radiation plate 32 is cooled efficiently.

In the fuel supply device 1 of the present embodiment, the heat-generating electronic elements 46, 48 of the control module are thermally connected to the upper end of the heat radiation plate 32 via the heat sink 44, and the lower end of the heat radiation plate 32 is immersed into the fuel inside the fuel tank 34. Therefore, whether the flow rate of the fuel discharged from the fuel pump 31 is large or small, the heat radiation plate 32 is in contact with the fuel stored inside the fuel tank 34. The heat of the electronic elements 46, 48 can be radiated to the fuel inside the fuel tank 34. Furthermore, because the heat of the control module is radiated to the entire fuel inside the fuel tank 34, the fuel supplied from the fuel pump 31 to the engine is prevented from overheating. As a result, vapor can be prevented from admixing to the fuel supplied to the engine, and the engine can be operated at an adequate air/fuel ratio.

Further, because the capacity of cooling the electronic elements 46, 48 can be adjusted by the surface area of the heat radiation plate 32, the desired cooling capacity can be easily obtained. In addition, the fuel returned by the pressure regulator 37 is ejected toward the heat radiation plate 32. Therefore, the heat radiation plate 32 can be cooled efficiently even when the amount of fuel stored in the fuel tank 34 has decreased.

Further, by directly attaching the electronic elements 46, 48 that are heat generating members to the heat radiation plate 32, the heat of the electronic elements 46, 48 can be radiated to the fuel via the heat radiation plate 32 with good efficiency.

In the present embodiment, the heat radiation plate 32 is held at the set plate 17 by chemically bonding the set plate 17 (partition member) and heat radiation plate 32 (heat radiation member), and the gap between the set plate 17 and the heat radiation plate 32 is sealed with the bonding layer 60 formed by such chemical bonding.

In a structure in which the gap between the set plate 17 and the heat radiation plate 32 is sealed with a conventional adhesive or a rubber O-ring, the adhesive or O-ring is exposed to the heat transferred by the beat radiation plate 32 or fuel contained inside the fuel tank 34. In addition the heat radiation plate 32 vibrates due to vibrations of the fuel pump. These factors induce degradation of the adhesive and O-ring and cause seal defects. However, in the present embodiment, because the set plate 17 and the heat radiation plate 32 are chemically bonded, the degradation induced by heat or fuel can be prevented and vibrations of the heat radiation plate 32 can be inhibited. As a result, degradation of the bonding layer 60 can be suppressed and the gap between the set plate 17 and heat radiation plate 32 can be sealed effectively over a long period.

A silane coupling agent can be used for chemically bonding the set plate 17 and the heat radiation plate 32. More specifically, first, the surface of the portion of the heat radiation plate 32 that is bonded to the set plate 17 may be washed and dried. Upon drying, the heat radiation plate 32 may be immersed into an aqueous solution of a silane coupling agent for an interval from several seconds to several minutes at normal temperature. The heat radiation plate 32 may be removed from the aqueous solution of the silane coupling agent, and dried without washing with water. The heat radiation plate 32 may be then disposed inside a mold, and the set plate 17 may be insert molded using a resin material. As a result, in the contact zone of the heat radiation plate 32 and the set plate 17, the bonding layer 60 that is an amorphous organometallic compound layer is formed over the entire circumference where the heat radiation plate 32 is in contact with the set plate 17. Therefore, the heat radiation plate 32 is strongly fixed to the set plate 17. Further, with the bonding layer 60, the heat radiation plate 32 and the set plate 17 can be bonded without a gap, and the fuel located inside the fuel tank 34 can be prevented from flowing into the accommodation portion 14. Well-known coupling agents such as vinyltriethoxysilane, vinyltris(2-methoxyethoxysilane), 3-methacryloxypropyltrimethoxysilane are used for chemically bonding the set plate and the heat radiation plate.

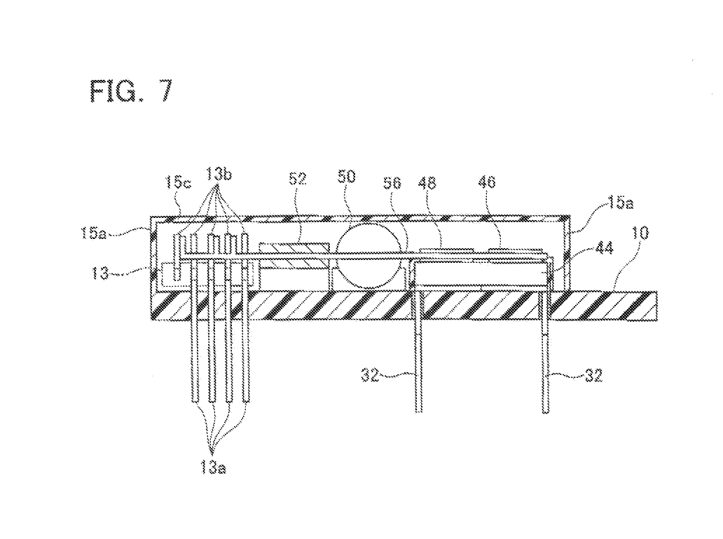

Further, when the set plate 17 is molded, the control module may be set together with the heat radiation plate 32 into a mold in advance and then the set plate 17 may be molded by injecting a resin into the mold. Thus, first, the heat radiation plate 32 is disposed inside the mold. Then, components (44, 46, 48, 50, 52, 56) of the control module are set in the mold. Finally, a resin is injected into the mold, and the set plate 17 including the circuit accommodation portion 14 is molded. In this embodiment shown in FIG. 7, a lid portion 15c closes the upper ends of the four wall portions 15a. With such configuration, moisture and dust can be prevented from penetrating into the control module even without filling with the potting material 58.

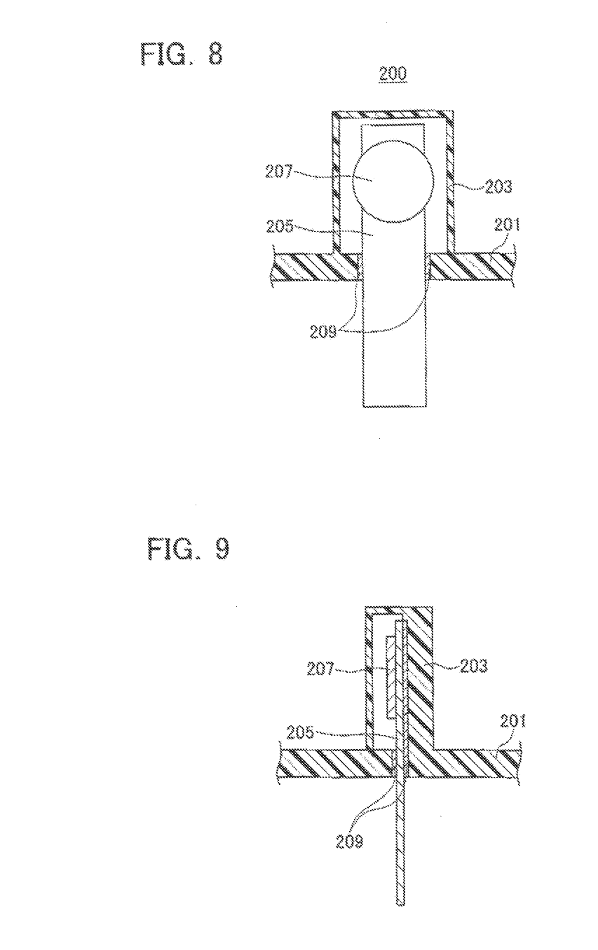

Further, as shown in FIGS. 8 and 9, a configuration in which the heat radiation plate is not bent also may be used, FIGS. 8 and 9 show schematically a cross section of a heat exchange device 200 attached to a fuel supply device. The heat exchange device 200 comprises a set plate 201, a accommodation portion 203, a heat radiation plate 205, and a drive control circuit 207. The accommodation portion 203 is formed on the upper surface of the set plate 201. The heat radiation plate 205 passes vertically through the set plate 201. The heat radiation plate 205 has one end thereof accommodated inside the accommodation portion 203. The drive control circuit 207 is disposed inside the accommodation portion 203. The drive control circuit 207 is mounted on one surface of the beat radiation plate 205. The other surface of the heat radiation plate 205 is joined to the accommodation portion 203 by chemical bonding, and an adhesive layer (bonding layer) 209 is formed between the heat radiation plate 205 and the accommodation portion 203. The heat radiation plate 205 passes vertically through the set plate 201 and is joined to the set plate 201 also by chemical bonding, whereby the adhesive layer (bonding layer) 209 is formed therebetween. A portion of the heat radiation plate 205 that is located below the set plate 201 is immersed into fuel located inside a fuel tank (not shown). With such configuration, the heat radiation plate 205 is chemically bonded not only to the set plate 201, but also to the accommodation portion 203. As a result, the accommodation portion 203 (i.e., set plate 201) can hold the heat radiation plate 205 with better stability. Furthermore, because the heat exchange device 200 does not require bending of the heat radiation plate 205, no unnecessary stresses are applied to the adhesive layer 209, and degradation of the adhesive layer 209 is prevented.

In the above-described heat exchange devices, heat generating members of the electronic elements are disposed in a gas space inside the accommodation portion. The heat of the heat generating members can be radiated to the fuel in the fuel tank via the heat radiation members. In such configuration, the heat of the beat generating members of the gas space can be radiated to the liquid inside the liquid space via the beat radiation member, without bringing the heat generating member into contact with the liquid inside the liquid space.

Further, in the above-described heat exchange devices, the accommodation portion accommodating the electronic elements is formed in the set plate that separates the electronic elements from the space inside the fuel tank. With a such configuration, because the partition member and the accommodation portion that accommodates the heat generating member are integrated, a fuel supply device of a simple structure can be obtained.

The set plate seals the mounting opening of the fuel tank. Thus, the set plate constitutes part of the outer shell of the fuel tank. With such a configuration, the structure can be simplified because the set plate that is a partition member is used as a wall of the fuel tank.

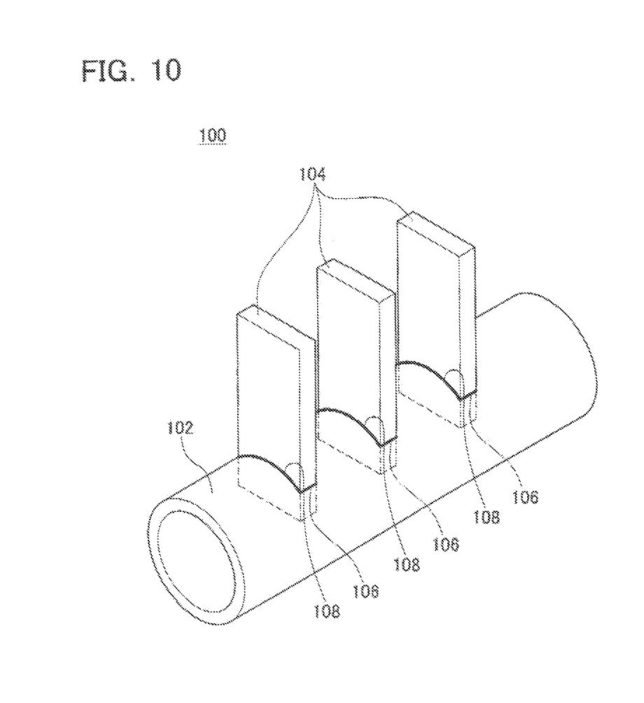

In the above-described embodiment, an example is considered in which the heat exchange device in accordance with the present teachings is applied to a fuel supply device. However, the heat exchange device in accordance with the present teachings can be also used for other applications. Further, in the above-described embodiment, an example is considered in which the heat from the gas space (i.e., heat of electronic components) is radiated to the fuel located inside the liquid space (i.e., the fuel tank), but a configuration may be also obtained in which heat of the liquid located inside the liquid space is radiated to the gas of the gas space. For example, in a cooling device of a water cooling system, heat of the cooling water that absorbed heat is radiated into atmosphere. Conventionally, the surface area is increased and cooling water is cooled by attaching a heat radiation plate made from a metal with a high thermal conductivity (e.g., copper, aluminum) to the outer peripheral surface of the tube where the cooling water flows. The technology of the present teachings can be also advantageously used in such heat exchange device. Thus, a heat exchange device 100, as shown in FIG. 10, comprises a resin tube 102 in which cooling water flows and heat radiation plates 104 made from a metal and attached to the tube 102. The heat radiation plates 104 are inserted via through holes 108 formed in the tube 102 from the other peripheral surface to the inner peripheral surface of the tube 102. A bonding layer 106 formed by chemically bonding the heat radiation plate 104 and the tube 102 is provided in the gap between the through hole 10 of the tube 102 and the heat radiation plate 104. The cooling water located inside the tube 102 radiates heat to the air outside the tube 102 via the heat radiation plate 104. As a result, the cooling water located inside the tube 102 is cooled. With such configuration, because the heat radiation plate 104 is in direct contact with the cooling water located inside the tube 102, heat of the cooling water can be absorbed with good efficiency. Further, because the heat radiation plate 104 and the tube 102 are joined by chemical bonding, the cooling water located inside the tube 102 is prevented from leaking to the outside of the tube 102.

In the above-described heat exchange device 100, the heat of the liquid introduced into the liquid space can be radiated to the gas introduced via the heat radiation member into the gas space. Thus, when the temperature of liquid introduced into the liquid space is higher than the temperature of the gas introduced into the gas space, heat is radiated from the liquid space to the gas space.

Specific examples of the present teachings are explained above, but they are merely illustrative examples and place no limitation on the claims. The technology described in the claims includes various changes and modifications of the above-described examples.

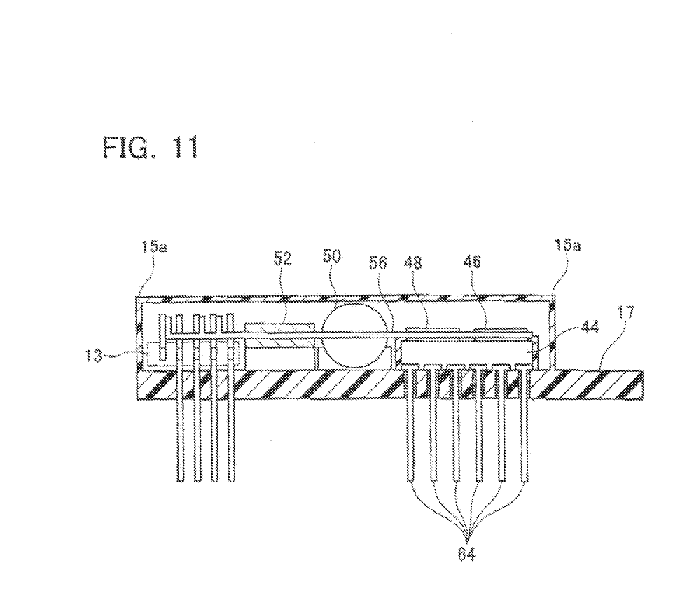

For example, in addition to the above-described sheet-shaped heat radiation plate 32, a rod-like heat radiation member 64 shown in FIG. 11 may be used. A bonding layer 65 may be formed by the above-described method in the contact portion of the heat radiation member 64 and set plate 17. This configuration also makes it possible to radiate the heat of electronic elements 46, 43.

Further, even when a radiation plate is used for the heat radiation member, the plate may have not only the sheet-like shape, but also a wave-like shape or a folded shape. As a result, the contact surface area of the heat radiation plate and fuel can be increased and heat radiation efficiency can be improved.

Further, the technological elements explained in the present specification or appended drawings demonstrate the technological utility when used individually or in various combinations thereof, and they are not limited to the combinations described in the claims at the date the application was filed. Further, the technology illustrated by the specification and the appended drawings attains a plurality of objects at the same time, and the technical utility is demonstrated by merely attaining one of these objects.

What is claimed is:

1. A heat exchange device comprising,
a partition wall that separates a first space from a second space, the partition wall being made from a resin and including a through hole extending from the first space to the second space; and
a heat radiation member fixed to the through hole, the heat radiation member being made from a metal, wherein one end of the heat radiation member is within the first space and the other end of the heat radiation member is within the second space, wherein
a bonding layer is chemically bonded to both of an outer surface of the heat radiation member and an inner surface of the through hole, and the bonding layer seals a gap between the heat radiation member and the through hole.

2. The heat exchange device as in claim 1, wherein the heat radiation member transmits heat from either the first or second space to the other space.

3. The heat exchange device as in claim 2, wherein a heat generating member is disposed within the first space, and the heat radiation member transmits heat generated by the heat generating member to the second space.

4. The heat exchange device as in claim 2, wherein the first space is filled with gas, liquid is introduced into the second space, and the other end of the heat radiation member is immersed into the liquid.

5. The heat exchange device as in claim 1, wherein the bonding layer is shaped so as to sealingly contact the heat radiation member and the partition wall.

6. The heat exchange device as in claim 6, wherein the bonding layer is a polymer layer.

7. The heat exchange device as in claim 5, wherein the bonding layer comprises triazinethiol derivative.

8. The heat exchange device as in claim 5, wherein the bonding layer comprises silane coupling agent.

9. A fuel supply device comprising.
a partition member that separates a first space from a second space, the partition member being made from a resin and including a through hole extending from the first space to the second space;
a fuel pump for discharging the fuel stored in the second space;
a control circuit for driving the fuel pump by using power supplied from a power source, the control circuit including a heat generating component; and
a heat radiation member fixed to the through hole of the partition member, the heat radiation member being made from a metal, one end of the heat radiation member being disposed within the first space and thermally connected to the heat generating component, and the other end of the heat radiation member being disposed within the second space, wherein
a bonding layer is chemically bonded to both of an outer surface of the heat radiation member and an inner surface of the through hole, and the bonding layer seals a gap between the heat radiation member and the through hole.

10. The fuel supply device according to claim 9, wherein the control circuit is disposed within the first space.

11. The fuel supply device according to claim 10, wherein the partition member comprises a cover portion attached to a mounting hole of a fuel tank.

12. The fuel supply device as in claim 11, wherein the bonding layer is shaped so as to sealingly contact the heat radiation member and the partition wall.

13. The fuel supply device as in claim 12, wherein the bonding layer comprises triazinethiol derivative.

14. The fuel supply device as in claim 12, wherein the bonding layer comprises silane coupling agent.

15. A fuel supply device comprising:
a cover attached to a fuel tank, the cover being made from resin, wherein the cover includes an inner space and a through hole extending from the inner space of the cover to an inside space of the fuel tank;
a fuel pump attached to the cover, the fuel pump discharging the fuel stored in the inside space of the fuel tank to an exterior of the fuel tank;
a control circuit disposed within the inner space of the cover, the control circuit driving the fuel pump by using power supplied from a power source, wherein the control circuit includes a heat generating component; and
a heat radiation member fixed to the through hole of the cover, the heat radiation member being made from metal, wherein one end of the heat radiation member is disposed within the inner space of the cover and thermally connected to the heat generating component, and the other end of the heat radiation member is disposed within the inside space of the fuel tank, and wherein
a bonding layer is chemically bonded to both of an outer surface of the heat radiation member and an inner surface of the through hole, and the bonding layer seals a Pan between the heat radiation member and the through hole.

16. The fuel supply device as in claim 15, wherein the other end of the heat radiation member disposed within the inside space of the fuel tank extends close to the lower end of the fuel tank.

17. The fuel supply device as in claim 16, further comprising a pressure regulator ejecting the fuel discharged from the fuel pump toward the heat radiation member.

18. The fuel supply device as in claim 16, wherein the bonding layer is shaped so as to sealingly contact the heat radiation member and the partition wall.

19. The fuel supply device as in claim 18, wherein the bonding layer comprises triazinethiol derivative.

20. The fuel supply device as in claim 18, wherein the bonding layer comprises silane coupling agent.
